(19) United States
(12) Patent Application Publication
(10) Pub. No.: US 2016/0253662 A1
(43) Pub. Date: Sep. 1, 2016

(54) METHOD TO USE A PAYMENT GATEWAY AS CONTEXTUAL ENABLER BETWEEN DIFFERENT PARTIES

(71) Applicant: VISA INTERNATIONAL SERVICE ASSOCIATION, San Francisco, CA (US)

(72) Inventors: Deepak Rao, Foster City, CA (US); Vijay Duraipalarn, Foster City, CA (US); Madhvesh Navkal Badri, Foster City, CA (US); Pavel Zolnikov, Foster City, CA (US)

(21) Appl. No.: 15/040,726

(22) Filed: Feb. 10, 2016

Related U.S. Application Data
(60) Provisional application No. 62/126,273, filed on Feb. 27, 2015.

(51) Int. Cl. G06Q 20/38; G06Q 30/06; G06Q 20/40

(52) U.S. Cl. CPC G06Q 20/3827; G06Q 20/3829; G06Q 20/401; G06Q 30/0635; G06Q 2220/00

(57) ABSTRACT

Disclosed is a system to enable enhancing data shared between different parties to take advantage of contextual applications by creating a parallel secure, compartmentalized and governable data storage and exchange framework. In an example, the system may provide for receiving an authorization request for a financial transaction, forwarding the request to a payment account issuer, creating a digital Topic, determining authorized parties to access the digital Topic, and determining a permission level for each of the authorized parties to access Topic elements of the digital Topic. In further aspects, in response to the authorization being approved, the example system may include communicating an approved authentication, receiving an itemized list of items purchased, adding the items to the Topic, notifying the authorized parties about creation of the Topic, and communicating a specific hash key to each of the authorized parties for accessing the Topic.

### CROSS REFERENCE TO RELATED APPLICATIONS

This application claims priority to, and the benefit of, U.S. Prov. App. Ser. No. 62/126,273, filed Feb. 27, 2015, entitled “Method to Use a Payment Gateway as Contextual Enabler Between Different Parties,” the entire content of which is incorporated herein by reference.

### BACKGROUND

ISO 8583 caters only to financial data transfer and it is not feasible to add new items (e.g., Image Transmission) to those messages. Moreover, enhancing ISO messages with additional data would require all parties involved in a payment transaction to make changes. This limits the ability to add innovative value additions.

### SUMMARY OF THE INVENTION

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

Disclosed is a system to enable enhancing data shared between different parties to take advantage of contextual applications by creating a parallel secure, compartmentalized and governable data storage and exchange framework. Existing capabilities of a payment gateway are leveraged and augmented to enable contextual applications between the parties involved in a payment transaction.

The use of a token/card at a point of sale (POS) or mobile wallet for a buy event by a consumer (e.g., cardholder) triggers sending of an authorization request to a payment processor. In response to receiving the authorization request (e.g., simultaneously), the payment processor creates a digital Topic for that event/consumer. After creation, the payment processor notifies and distributes unique hash-keys, to different involved parties—Consumer/Authorized Third party Apps, Issuer, Acquirer and Merchant—which enables secure access/disk space for that particular digital Topic. The Consumer and/or his/her authorized third party application has read/write permission to all the contents of the Topic. Other parties (e.g., Issuer, Acquirer and Merchant) involved in the “Topic” may have only sequential write/read access to a particular Topic. This enables context sharing between the involved parties.

In accordance with example embodiments, a system, method, apparatus, and computer readable medium are disclosed. The example embodiments may provide for receiving an authorization request for a financial transaction, forwarding the request to a payment account issuer, creating a digital Topic, determining authorized parties to access the digital Topic, and determining a permission level for each of the authorized parties to access Topic elements of the digital Topic. In further aspects, in response to the authorization being approved, the example embodiments may include communicating an approved authentication, receiving an itemized list of items purchased, adding the items to the Topic, notifying the authorized parties about creation of the Topic, communicating a specific hash key to each of the authorized parties for accessing the Topic.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an embodiment of an example flow diagram of a method in accordance with example embodiments;

FIG. 2 is a view of data flow related to a digital Topic;

FIG. 3 illustrates four common parties to an electronic payment transaction;

FIG. 4 illustrates an example lifecycle of a Topic;

FIG. 5 is an illustration of a computer system;

FIG. 6 is an illustration of a portable computing device; and

FIG. 7 is an illustration of a server computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

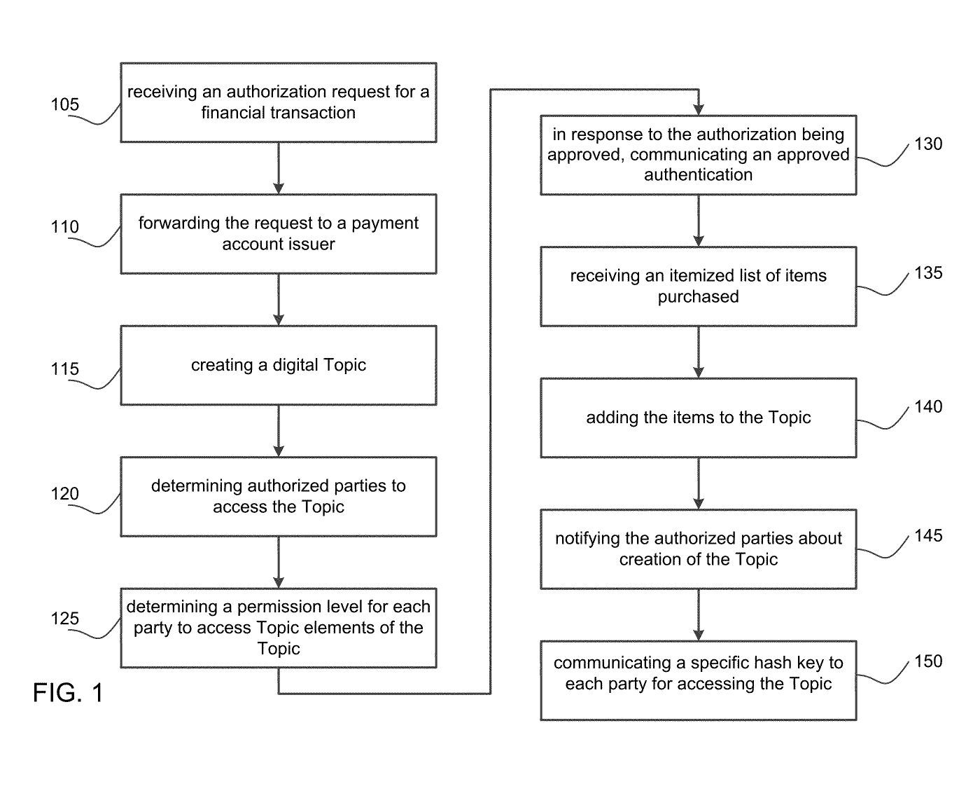

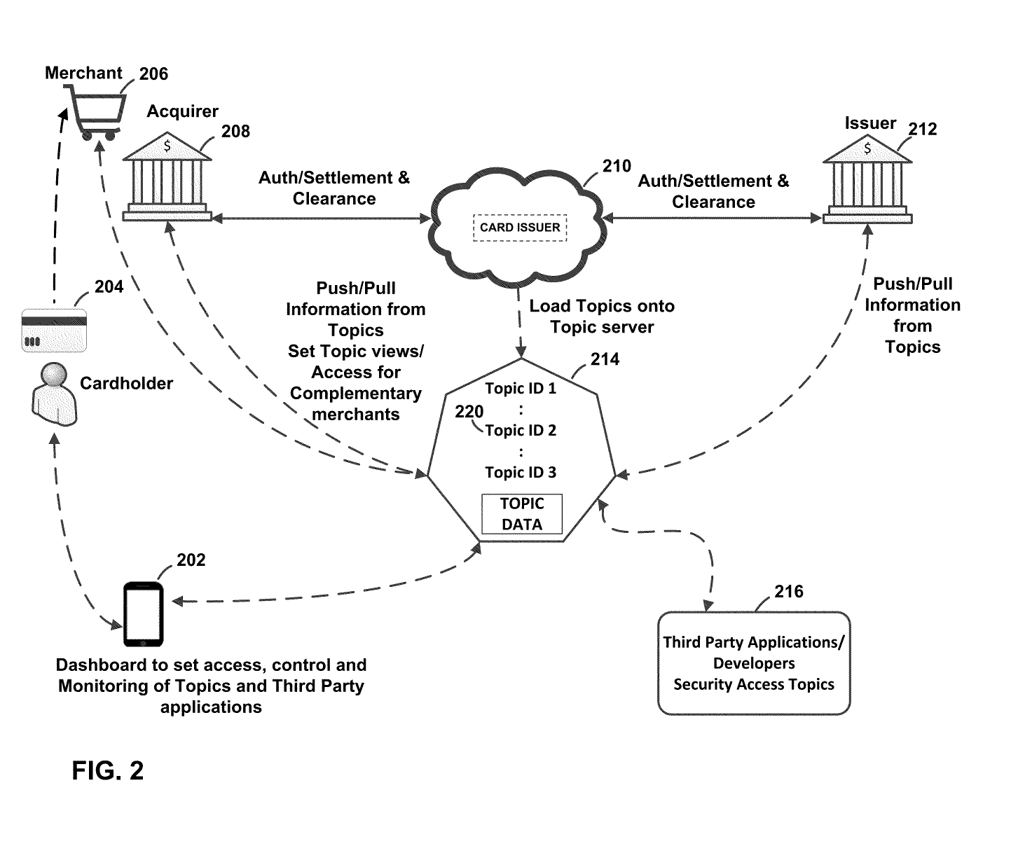

As illustrated in FIGS. 1 and 2, a computer system may be created for reviewing transactions. The computer system may have at least one processor which may be physically configured according to computer executable instructions stored by at least one memory or other non-transitory computer readable medium. The computer executable instructions may be understood as blocks of code. FIG. 1 may illustrate the blocks of code that physically configure the processor.

At block 105, an authorization request for a financial transaction may be received. In an example, a consumer may enroll with a payment account issuer to receive a portable payment device that may be used when purchasing an item (e.g., a good or a service). A portable payment device may represent one or more accounts a user has established with the issuer. Before charges are made to an account, the charge may have to be authorized by an authority to avoid a fraudulent charge. Logically, the authorization request may be accepted or denied. With reference to FIG. 2, for example, a consumer may present a payment device 204 to a merchant 206 when purchasing an item. A point of sale (POS) terminal may generate and send an authorization request to an acquirer 208 based on information obtained from the payment device 204 (e.g., account number, etc.). In an example, an acquirer 208, as well as the other entities described herein, may have computerized systems such as one or more servers for processing financial transactions.

As used herein, a “payment device” may refer to any device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode.

At block 110, the authorization request may be forwarded to a payment account issuer. In addition, the authorization request may be communicated to the payment instrument issuer via a payment processor (e.g., VISA). Logically, payment accounts may be issued by one or more issuers. The issuer may track debits and credits for the consumer. If there are sufficient funds or credit, the charge may be authorized. If the request is approved, the payment account issuer may create the required debits and credits. With reference again to FIG. 2, acquirer 208 may, for example, communicate an ISO authorization message to an issuer 212 via a payment processor 210 for settlement and clearance.

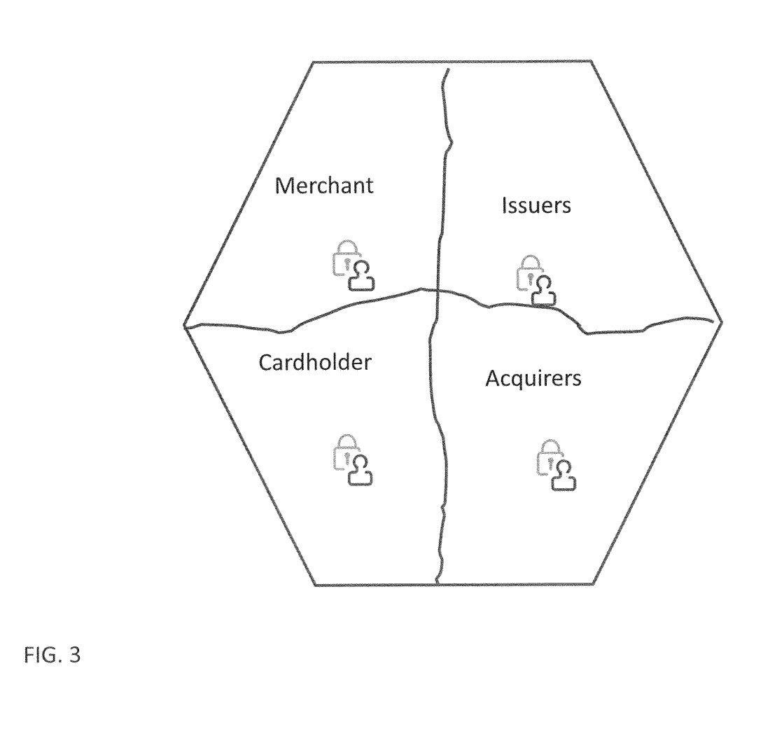

At block 115, a digital Topic may be created. The Topic 220 may be a secure digital file containing a variety of elements with various permission levels granted to appropriate parties to view, read to, and/or write to some or all of the elements. In an example, the payment processor 210 may forward payment transaction data obtained from the authorization request to a Topic server 214 for creation of a digital Topic 220. In an example, a digital Topic 220 may be a database record that includes information about a payment transaction. The Topic 220 may be associated with a variety of parties that interact to approve a particular payment transaction. For example, as illustrated in FIG. 3, there are commonly four parties to a transaction, specifically a merchant 206, a consumer, a payment account issuer 212 and a merchant acquirer 208, and each may have a different permission level to view the data in the Topic 220. A merchant authorized party usually sells a good or service. A consumer authorized party usually buys a good or service. A payment account issuer usually issues the payment device and assists in reviewing transactions for fraud and authorizing transaction. A merchant acquirer usually assists the merchant in processing transactions.

Topics may include data related to a current financial transaction and past transactions. For example, the digital Topic 220 may include a date of purchase of an item(s), an identification of the item(s) purchased, an identification of the merchant that sold the item(s), a receipt for a purchase, a category of the merchant (e.g., sporting goods, travel, etc.) and other relevant information about a purchase. Further, consumers may be able to add more information to the Topic 220 such as items desired, price changes over time, things to be purchased in the short term, things to be purchased in the long term, etc.

Further, the Topic 220 may be extensible and may be modified by a consumer to fit the needs of the individual consumer. For example, the consumer may be able to set thresholds related to purchase amounts and different reports or access rights may be created based on the thresholds. In addition, a consumer may be able to upload data to the Topic 220 such as images, lists, requests, etc.

At block 120, authorized parties to access a Topic may be determined. As mentioned previously, there are four traditional parties in a credit transaction and those authorized parties may be authorized to view the Topic 220. To set what parties can access a Topic, the consumer may access a dashboard specifying what party(ies) has rights to access a digital Topic, and the Topic server 214 may permit access based on the consumer's specifications. In addition, the consumer may provide another user permission to access the Topic 220. For example, a consumer may be able to authorize a spouse to view a Topic 220.

At block 125, a permission level to access the Topic for each authorized party to access the Topic 220 may be determined. Each of the authorized parties to a Topic 220 may have a default permission level wherein the permission level controls access to data of the Topic 220. The permission level may specify what type of rights an entity has (e.g., read only, read and write, etc.) and the rights may be granted only for certain elements (e.g., permission to read only a first element, and permission to read and write to a second element). In an example, a consumer may have access to all the data elements in a Topic 220. A merchant may have access only to the data elements related to items purchased from that merchant. A card issuer may only have access to data elements that relate to the ability to predict fraud. The consumer may have the ability to adjust the default permissions as desired.

A consumer may also assign a partner permission level permitting an authorized party to permit at least one partner party to view a digital Topic 220. For example, an acquirer 208 may have relationships with other merchants, and may desire to permit the other merchants to read and/or write to a digital Topic 220 for marketing to the consumer. To enable this functionality, the consumer may set a partner permission level that authorizes the acquirer 208 to provide its partners with read and/or write level access to the digital Topic 220 or category of digital Topics.

A consumer may also set a permission level for other individuals. For example, a consumer may permit other users (e.g., family members) to read and/or write to a digital Topic 220. In one example, a digital Topic 220 may identify what items a child has purchased for review by his/her parents. In another example, a digital Topic 220 may indicate that a husband stopped at a convenience store and bought milk earlier in the day.

At block 130, in response to the authorization being approved, an approved authentication may be communicated. Like in a traditional transaction, before value changes hands, the transaction may be authorized. Authorization continues to evolve as fraudulent threats change and morph over time and such authorization changes are contemplated. For example, issuer 212 may approve a transaction and send an approval message to the POS of the merchant 206 via the payment processor 210 and the acquirer 208.

At block 135, an itemized list of items purchased may be received. The merchant may have a database that tracks the items purchased for inventory purposes and for accounting purposes. In the past, items purchased were not communicated broadly through the transaction system. However, with sufficient permissions, the items purchased may be communicated to the Topic 220 and may be available to the members of the transaction. For example, the POS of the merchant 206 may communicate an itemized list message and a topic identifier to the Topic server 214.

At block 140, the items purchased may be added to the Topic 220. The items purchased by a consumer also may be made part of a Topic 220. In this way, a consumer may be able to search and review past transactions. In addition, if sufficient permissions are provided, a merchant may be able to review past items purchased by a consumer and may be able to use this information to provide more targeted offers, remind a user when a periodic purchase is due, etc. For example, the Topic server 214 may use the received topic identifier to identify a particular digital Topic 220 and update the Topic 220 with the items provided in the itemized list message. In an example, the itemized list message may include stock keeping units (SKUs) of the items purchased by the consumer.

At block 145, the authorized parties may be notified about creation of the Topic 220. In an example, a Topic server 214 may inform authorized parties about creation, modification, and deletion of a Topic 220. For instance, the Topic server 214 may communicate a notify message to authorized parties each time a digital Topic 220 is created, modified, or deleted.

The Topic server 214 may also provide a dashboard that permits a consumer to control access to the consumer's digital Topics. A dashboard may be, for example, a web-based graphical user interface that a user device 202 may access to manipulate digital Topics. In an example, the Topic server 214 may authenticate a consumer and limit the consumer only to accessing his/her digital Topics. For example, consumer may cause the user device 202 to send a token request that includes a token identifier of the desired Token 220 and a code associated with a hash key assigned to the digital Token and provided to the user by the Token server 214. For example, the user device 202 may encrypt token identifier with the specific hash key, and the Token server 214 may decrypt the encrypted token identifier to authenticate the consumer. Other authentication methods may also be used.

Via the dashboard, a consumer may control what parties may access a digital Topic 220 (or category of digital Topic 220) and control what type of access each party has to a Topic 220 (e.g., read only access, write access, etc.). The dashboard may also provide the consumer with information on about each Topic 220 (e.g., activity, who has accessed (e.g., third party applications, issuers, acquirers), etc.).

In this way, the parties can track Topics and be aware that the Topic 220 is available for review. Further, authorized parties may include event triggers in a Topic 220 to have the Topic server 214 communicate information to authorized parties or additional parties or sites if desired. For example, a consumer may create an event trigger that notifies a spouse if a purchase over $500 is made.

At block 150, a specific hash key to access the Topic may be communicated to each of the authorized parties. A hash key may provide security that the Topics will only be available for access by the desired parties. Further, the keys may also control access such that the consumer may have full access to the Topic 220 while merchants may have more limited access, such as to the item the consumer purchased from that merchant. The hash key may be necessary to access the Topic 220. The Topic 220 server 214 may distribute a hash key to each authorized party in a secure manner. When desiring to access a particular digital Topic 220, the requesting party may communicate to the Topic server 214 a token request that includes an identifier of the requested token, an identifier of the party requesting the token, and a code encrypted with the hash key (e.g., encrypt the party identifier). The Topic 220 server 214 may decrypt the code to authenticate the requesting party to authenticate the requesting party. Other mechanisms involving the hash key for authentication may also be used.

Once authenticated, the requesting party may push or pull information from a digital Topic 220. A party that pushes information to a Topic 220 may be required to have a write access permission level, and a party that pulls information from a Topic 220 may be required to have a read access permission level. The Topic server 214 may confirm that a requesting party has the appropriate permission level before pushing/pulling and may deny any request outside of the party's permission level. In an example, an acquirer 208 may have a partner permission level permitting its partners to read and/or write to a digital Topic 220 for marketing items to the consumer available from partner merchants. The acquirer 208 may offer an incentive (e.g., points, rebates, discounts, etc.) to the consumer for permitting partners to access the consumer's digital Topic 220s.

The Topic 220 may be stored in any type of database and like any database, the Topics may be sorted in a variety of ways. For example, a consumer may sort Topics by dollar amount, by merchant, or by items. Similarly, a merchant may sort items by dollar value or date purchased. The Topic data may be subject to algorithms which may attempt to come to conclusions and make predictions about the future using the data.

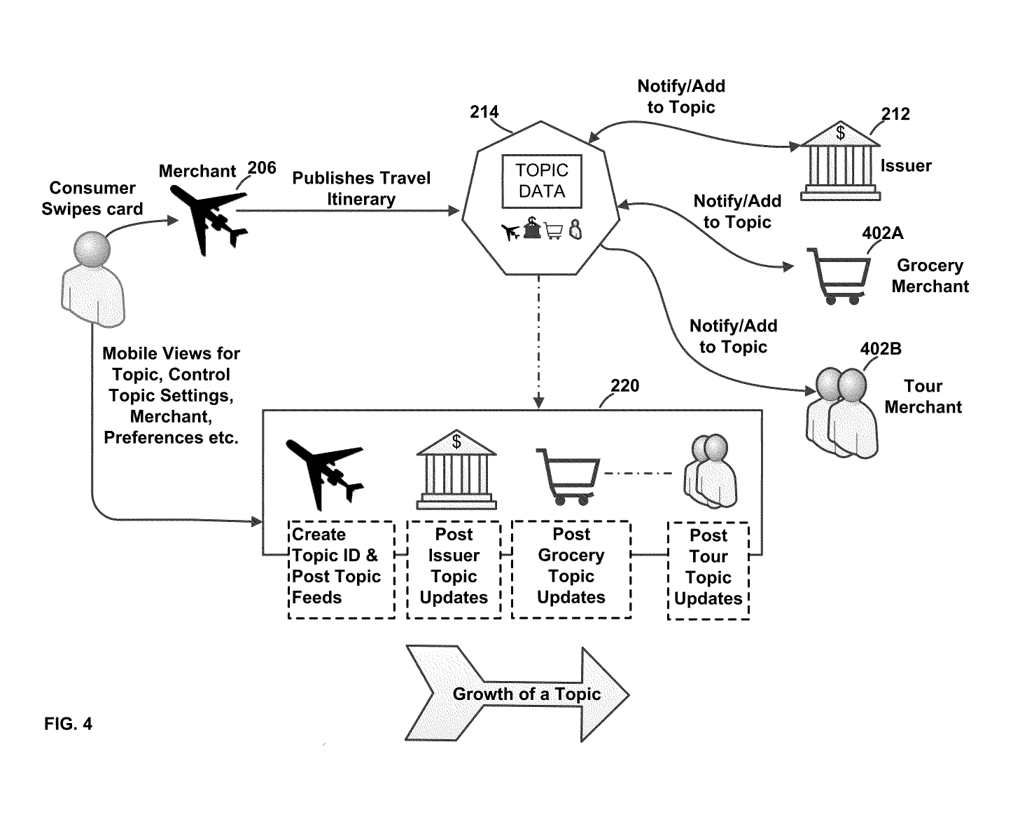

As an example as illustrated in FIG. 4, a user may purchase an airline ticket from an airline merchant 206. The airline merchant 206 may publish a travel itinerary that Topic server 214 uses, along with payment transaction data, to create a digital Topic 220. For example, the Topic 220 may contain data related to the airline ticket such as origination city, destination city, and dates of travel, and an identifier of a consumer that purchased the airline ticket. In this example, an issuer 212 and partner merchants 402A-B (e.g., a grocery merchant and a tour merchant) may have permission to read and/or write to the digital Topic 220. After creation, the Topic 220 server 214 may notify the issuer 212 and partner merchants 402A-B about creation of the digital Topic 220, and the issuer and/or partner merchants 402A-B may read and/or add to the digital Topic 220.

Growth of a Topic 220 in this example is shown at the bottom of FIG. 4. As depicted, an airline merchant 206 may instruct the Topic server 214 to create the digital Topic 220 which is assigned a Topic identifier. The Topic server 214 may post Topic 220 feeds to notify other authorized parties about creation of the digital Topic 220. For example, an authorized party may create an alert within a particular Topic 220 category (e.g., travel), and the Topic server 214 may send an alert to the authorized party whenever a digital Topic 220 is created in that category. In this example, the card issuer 212 may note in the digital Topic 220 that the consumer will be in, and charges may occur in, a different geographic location than where his/her normal purchasing activity occurs. A grocery merchant 402A may be notified that a Topic 220 has been created, and in response may remind the consumer that only items of a given size may be carried onto an airplane and may inform the consumer about items below that given size available for purchase from the merchant 402A. In another example, a tour merchant 402B may update the digital Topic 220 to provide the consumer with an offer for a discount on a tour. In another example, a partner merchant with permission may view the Topic 220 and offer a hotel in the destination city.

The system may be useful to consumers for tracking and sharing their purchases. For example, a family may set up an alert when a digital Topic 220 is created for purchases within a grocery category. In an example, if one spouse picks up bread on the way home from work, the Topic server 214 may push an alert to the other spouse indicating that bread has been bought and that another stop for bread is not necessary.

Other parties to a payment transaction may find a digital Topic 220 useful for a variety of reasons such as whether a sale is working or if a consumer has switched to a different store. In addition, rewards may be offered to a consumer to take part in the system. Logically, the system may be accessed through a mobile computing device, through a desktop computing device, through an ATM or through any other suitable computing device.

In a merchant to merchant example, one partner merchant may update a digital Topic 220 to inform other partner merchants about what a consumer has already bought and/or changes to a consumer's travel itinerary. In an issuer to merchant example, an issuer can up/match rewards and offers by merchants immediately or post transaction. For example, an issuer may access a digital Topic 220 before, during, or after when payment is being authorized and while the consumer is still interacting with a merchant. The issuer may provide a surprise loyalty gift, e.g., via a merchant's POS terminal (e.g., “here's a coupon for a free cup of coffee as thanks for being a loyal customer”, etc.). In a merchant to consumer example, a merchant can use a digital Token to keep a consumer aware of product recalls, create a grocery list (e.g., set a reminder for a user that typically buys milk and eggs every Friday), provide the consumer with an electronic receipt, and the like. In a third party app example, a third party app developer may utilize one or more digital Topics to create a sophisticated electronic receipt for the consumer.

The example embodiments may also provide technical solutions to one or more technical challenges. Existing payment processing networks and electronic messaging schemes fail to notify interested parties about a financial transaction nor use such a transaction to notify interested parties about the transaction. The example embodiments provide a digital Topic 220 to overcome these and other challenges with existing payment processing networks and electronic messaging schemes. The digital Topic 220 may provide a centralized sharing mechanism for storing data about a consumer and his/her transactions.

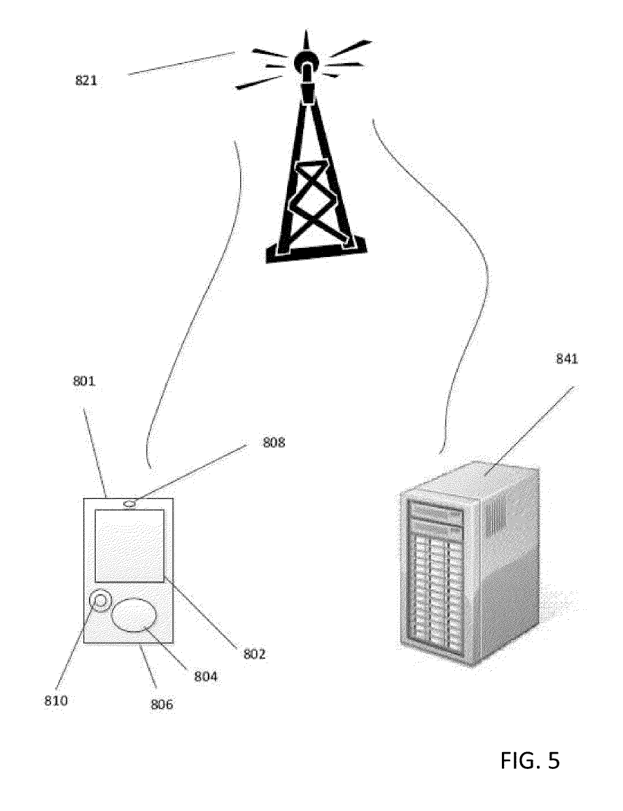

FIG. 5 may be a high level illustration of some of the elements a sample computing system that may be physically configured to implement the method and system. The computing system may be a dedicated computing device 841, a dedicated portable computing device 801, an application on the computing device 841, an application on the portable computing device 801 or a combination of all of these. FIG. 5 may be a high level illustration of a portable computing device 801 communicating with a remote computing device 841 but the application may be stored and accessed in a variety of ways. In addition, the application may be obtained in a variety of ways such as from an app store, from a web site, from a store WiFi system, etc. There may be various versions of the application to take advantage of the benefits of different computing devices, different languages and different API platforms.

In one embodiment, a portable computing device 801 may be a device that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

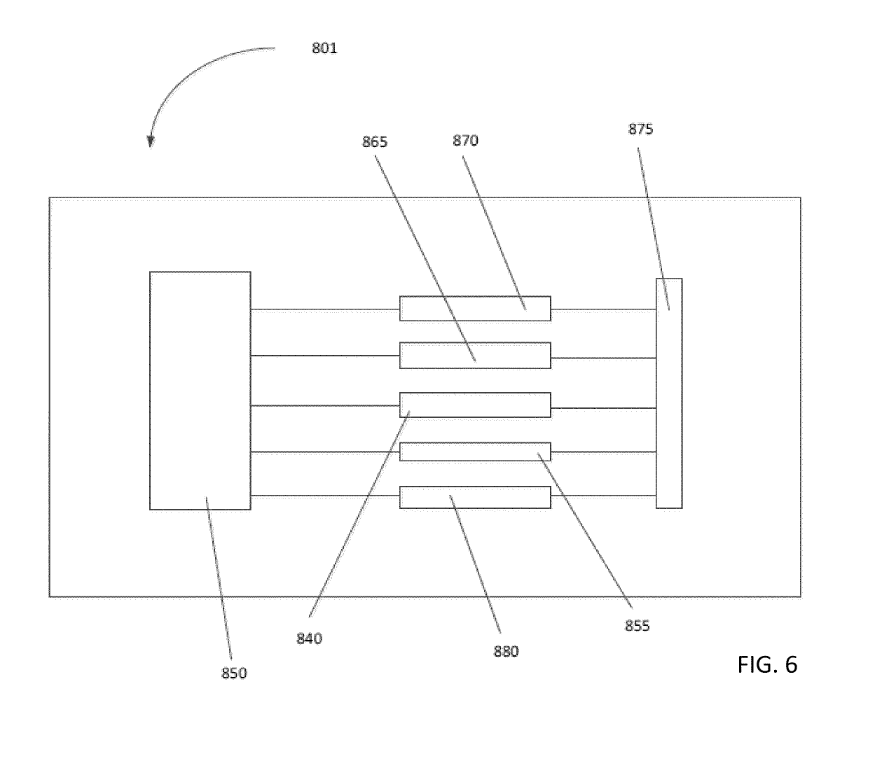

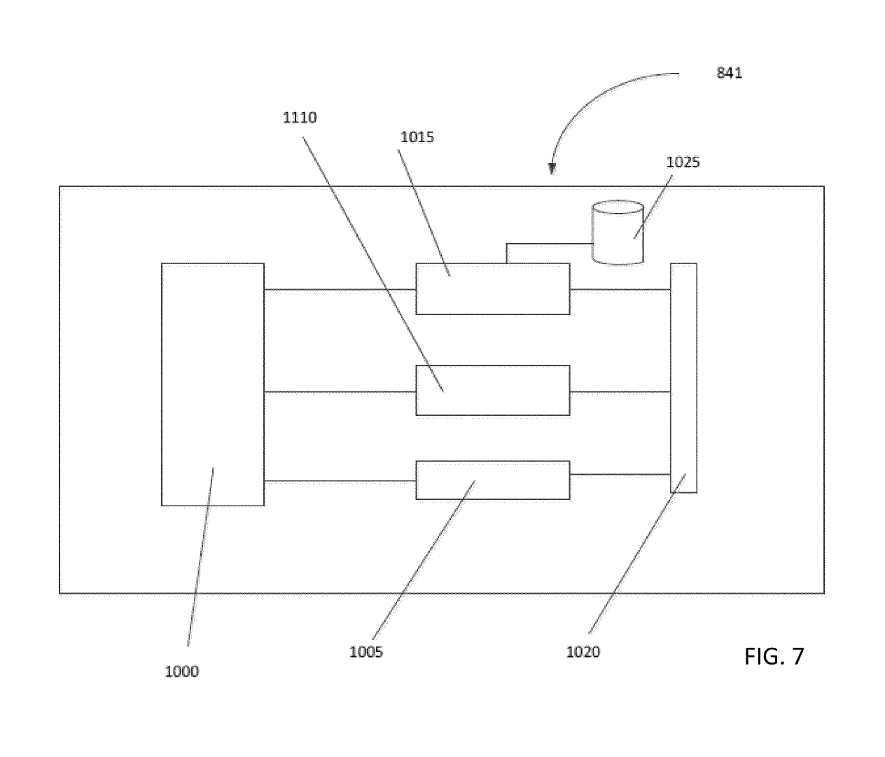

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs 802, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs 802, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated. The attached Appendix may provide more detail regarding the operation of a payment system.

The present disclosure provides a solution to the long-felt need described above. In particular, the systems and methods described herein may be configured for improving payment systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer system for reviewing transactions comprising:
at least one processor; and
at least one memory storing computer executable instructions that, when executed by the at least one processor, cause the computer system at least to perform:
receiving an authorization request for a financial transaction;
forwarding the request to a payment account issuer;
creating a digital Topic;
determining authorized parties to access the digital Topic;
determining a permission level for each of the authorized parties to access Topic elements of the digital Topic;
in response to the authorization being approved,
communicating an approved authentication;
receiving an itemized list of items purchased;
adding the items to the Topic; and
notifying the authorized parties about creation of the Topic and communicating a specific hash key to each of the authorized parties for accessing the Topic.

2. The computer system of claim 1, wherein the computer executable instructions, when executed by the at least one processor, cause the computer system at least to perform providing a reward to a consumer for granting a partner merchant permission to access the Topic.

3. The computer system of claim 1, wherein the computer executable instructions, when executed by the at least one processor, cause the computer system at least to perform providing a receipt to a consumer as part of the Topic.

4. The computer system of claim 1, wherein the authorized parties include at least one of a merchant, a consumer authorized party, a payment account issuer, and a merchant acquirer.

5. The computer system of claim 1, wherein each of the authorized parties to the Topic has a permission level wherein the permission level controls what level of access a particular one of the authorized parties has to access data of the Topic.

6. The computer system of claim 1, wherein the digital Topic further comprises at least one of a date of purchase of an item, identification of an item purchased, and identification of a merchant that sold the item.

7. The computer system of claim 1, wherein the computer executable instructions, when executed by the at least one processor, cause the computer system at least to perform processing a token request associated with a hash key to grant a consumer access to the Topic.

8. The computer system of claim 1, wherein the computer executable instructions, when executed by the at least one processor, cause the computer system at least to perform notifying at least one of the authorized parties about modification of the Topic based on processing a trigger associated with the Topic.

9. A non-transitory computer readable medium storing computer executable instructions that, when executed, cause an computer system at least to perform:
receiving an authorization request for a financial transaction;
forwarding the request to a payment account issuer;
creating a digital Topic;
determining authorized parties to access the digital Topic;
determining a permission level for each of the authorized parties to access Topic elements of the digital Topic;
in response to the authorization being approved,
communicating an approved authentication;
receiving an itemized list of items purchased;
adding the items to the Topic; and
notifying the authorized parties about creation of the Topic and communicating a specific hash key to each of the authorized parties for accessing the Topic.

10. The computer readable medium of claim 9, wherein the computer executable instructions, when executed by the at least one processor, cause the computer system at least to perform providing a reward to a consumer for granting a partner merchant permission to access the Topic.

11. The computer readable medium of claim 9, wherein the computer executable instructions, when executed by the at least one processor, cause the computer system at least to perform providing a receipt to a consumer as part of the Topic.

12. The computer readable medium of claim 9, wherein each of the authorized parties to the Topic has a permission level wherein the permission level controls what level of access a particular one of the authorized parties has to access data of the Topic.

13. The computer readable medium of claim 9, wherein the computer executable instructions, when executed by the at least one processor, cause the computer system at least to perform processing a token request associated with a hash key to grant a consumer access to the Topic.

14. The computer readable medium of claim 9, wherein the computer executable instructions, when executed by the at least one processor, cause the computer system at least to perform notifying at least one of the authorized parties about modification of the Topic based on processing a trigger associated with the Topic.

15. A computer-implemented method comprising:
receiving an authorization request for a financial transaction;
forwarding the request to a payment account issuer;
creating, by at least one processor, a digital Topic;
determining, by the at least one processor, authorized parties to access the digital Topic;
determining, by the at least one processor, a permission level for each of the authorized parties to access Topic elements of the digital Topic;
in response to the authorization being approved,
communicating an approved authentication;
receiving an itemized list of items purchased;
adding, by the at least one processor, the items to the Topic; and
notifying the authorized parties about creation of the Topic and communicating a specific hash key to each of the authorized parties for accessing the Topic.

16. The method of claim 15, further comprising providing a reward to a consumer for granting a partner merchant permission to access the Topic.

17. The method of claim 15, further comprising providing a receipt to a consumer as part of the Topic.

18. The method of claim 15, wherein each of the authorized parties to the Topic has a permission level wherein the permission level controls what level of access a particular one of the authorized parties has to access data of the Topic.

19. The method of claim 15, further comprising processing a token request associated with a hash key to grant a consumer access to the Topic.

20. The method of claim 15, further comprising notifying at least one of the authorized parties about modification of the Topic based on processing a trigger associated with the Topic.
